(19) United States
(12) Patent Application Publication
(10) Pub. No.: US 2026/0067007 A1
(43) Pub. Date: Mar. 5, 2026

(54) METHODS AND APPARATUS FOR UPLINK TRANSMISSION

(71) Applicant: Nokia Technologies Oy, Espoo (FI)

(72) Inventors: Sami-Jukka HAKOLA, Kempele (FI); Matha DEGHEL, Montrouge (FR); Keeth Saliya Jayasinghe LADDU, Espoo (FI); Mihai ENESCU, Espoo (FI); Juha Pekka KARJALAINEN, Sotkamo (FI)

(21) Appl. No.: 19/103,147

(22) PCT Filed: Jul. 7, 2023
(86) PCT No.: PCT/EP2023/068804

§ 371 Date: Feb. 11, 2025

(30) Foreign Application Priority Data
Aug. 12, 2022 (FI) 20227108

(51) Int. Cl. H04B 17/21; H04B 7/0404; H04B 17/345; H04L 5/00; H04W 72/23

(52) U.S. Cl. CPC H04B 17/21; H04B 7/0404; H04B 17/345; H04L 5/0048; H04W 72/23

(57) ABSTRACT

Embodiments of the present disclosure relate to methods and apparatus for simultaneous uplink (UL) multi-panel transmission. A terminal device obtains at least one measurement value of a reference signal over two or more antenna groups of the terminal device; and reports an indication to a network device based on the measurement value, wherein the indication indicates at least one uplink transmission scheme that can be used. In this way, the terminal device can determine a proper transmission scheme for the multi-panel uplink transmission of the two or more antenna groups with higher reliability and/or higher UL throughput according to actual network conditions.

### FIELD

Various example embodiments relate to the field of telecommunication and in particular, to methods, devices, apparatuses and a computer readable storage medium for uplink (UL) transmission.

### BACKGROUND

In a communication network, user equipment (UE) may have multiple transmit and receive antenna panels and operate using narrower RF beams than omni pattern for both the reception and transmission. Enhancements on simultaneous UL transmission for multi-panel UEs (MP-UEs) are still needed.

### SUMMARY

In general, example embodiments of the present disclosure provide a solution for UL multi-panel transmission.

In a first aspect, there is provided a terminal device. The terminal device may comprise one or more transceivers; and one or more processors communicatively coupled to the one or more transceivers, wherein the one or more processors are configured to cause the terminal device to: obtain at least one measurement value of a reference signal over two or more antenna groups of the terminal device; and report an indication to a network device based on the measurement value, wherein the indication indicates at least one uplink transmission scheme that can be used.

In a second aspect, there is provided a network device. The network device may comprise one or more transceivers; and one or more processors communicatively coupled to the one or more transceivers, wherein the one or more processors are configured to cause the network device to: obtain an indication from a terminal device, wherein the indication indicates at least one uplink transmission scheme that can be used for two or more antenna groups; and receive, from the terminal device, an uplink transmission using the uplink transmission scheme indicated by the indication.

In a third aspect, there is provided a method at a terminal device. The method may comprise obtaining, by a terminal device, at least one measurement value of a reference signal over two or more antenna groups of the terminal device; and reporting, by the terminal device, an indication to a network device based on the measurement value, wherein the indication indicates at least one uplink transmission scheme that can be used.

In a fourth aspect, there is provided a method at a network device. The method may comprise obtaining, by a network device, an indication from a terminal device, wherein the indication indicates at least one uplink transmission scheme that can be used for two or more antenna groups; and receiving, by the network device from the terminal device, an uplink transmission using the uplink transmission scheme indicated by the indication.

In a fifth aspect, there is provided an apparatus. The apparatus may comprise: means for obtaining, at a terminal device, at least one measurement value of a reference signal over two or more antenna groups of a terminal device; and means for reporting an indication to a network device based on the measurement value, wherein the indication indicates at least one uplink transmission scheme that can be used.

In a sixth aspect, there is provided an apparatus. The apparatus may comprise: means for obtaining, at a network device, an indication from a terminal device, wherein the indication indicates at least one uplink transmission scheme that can be used for two or more antenna groups; and means for receiving, from the terminal device, an uplink transmission using the uplink transmission scheme indicated by the indication.

In a seventh aspect, there is provided a terminal device. The terminal device may comprise at least one processor; and at least one memory including computer program codes, wherein the at least one memory and the computer program codes are configured to, with the at least one processor, cause the terminal device to: obtain at least one measurement value of a reference signal over two or more antenna groups of the terminal device; and report an indication to a network device based on the measurement value, wherein the indication indicates at least one uplink transmission scheme that can be used.

In an eighth aspect, there is provided a network device. The network device may comprise at least one processor; and at least one memory including computer program codes, wherein the at least one memory and the computer program codes are configured to, with the at least one processor, cause the network device to: obtain an indication from a terminal device, wherein the indication indicates at least one uplink transmission scheme that can be used for two or more antenna groups; and receive, from the terminal device, an uplink transmission using the uplink transmission scheme indicated by the indication.

In a ninth aspect, there is provided a non-transitory computer readable medium comprising program instructions for causing an apparatus to perform at least the method according to any one of the above third to fourth aspect.

In a tenth aspect, there is provided a computer program comprising instructions, which, when executed by an apparatus, cause the apparatus at least to: obtain at least one measurement value of a reference signal over two or more antenna groups of the terminal device; and report an indication to a network device based on the measurement value, wherein the indication indicates at least one uplink transmission scheme that can be used.

In a eleventh aspect, there is provided a computer program comprising instructions, which, when executed by an apparatus, cause the apparatus at least to: obtain an indication from a terminal device, wherein the indication indicates at least one uplink transmission scheme that can be used for two or more antenna groups; and receive, from the terminal device, an uplink transmission using the uplink transmission scheme indicated by the indication.

In a twelfth aspect, there is provided a terminal device. The terminal device may comprise: obtaining circuitry configured to obtain at least one measurement value of a reference signal over two or more antenna groups of the terminal device; and reporting circuitry configured to report an indication to a network device based on the measurement value, wherein the indication indicates at least one uplink transmission scheme that can be used.

In a thirteenth aspect, there is provided a network device. The network device may comprise: obtaining circuitry configured to obtain an indication from a terminal device, wherein the indication indicates at least one uplink transmission scheme that can be used for two or more antenna groups; and receiving circuitry configured to receive, from the terminal device, an uplink transmission using the uplink transmission scheme indicated by the indication.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates an example of a process for the scheme determination for simultaneous UL multi-panel transmission according to some embodiments of the present disclosure;

FIG. 3A illustrates a first example scenario of multi-panel UL transmission in the example communication network in FIG. 1;

FIG. 3B illustrates an example diagram of reference signal receiving power (RSRP) results based on measurements of UL reference signals in the example transmission in FIG. 3A;

FIG. 3C illustrates a second example scenario of multi-panel UL transmission in the example communication network in FIG. 1;

FIG. 3D illustrates an example diagram of RSRP results based on measurements of UL reference signals in the example transmission in FIG. 3C;

FIG. 3E illustrates a third example scenario of multi-panel UL transmission in the example communication network in FIG. 1;

FIG. 3F illustrates an example diagram of RSRP results based on measurements of UL reference signals in the example transmission in FIG. 3E;

FIG. 4 illustrates a flowchart of a method implemented at a terminal device according to some embodiments of the present disclosure;

FIG. 5 illustrates a flowchart of a method implemented at a network device according to some embodiments of the present disclosure;

FIG. 6 illustrates a simplified block diagram of an apparatus that is suitable for implementing embodiments of the present disclosure; and

FIG. 7 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G), or the further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “TRP” refers to a transmission reception point having an antenna array (with one or more antenna elements) at the network side located at a specific geographical location, which may be used for transmitting and receiving signals to/from the terminal device. In embodiment of the present disclosure, a TRP may refer to Macro Cell, micro cell, an RRH, a relay, a femto node, a pico node, etc. Although some embodiments of the present disclosure are described with reference to two TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Some embodiments described herein may relate to 3^{rd} generation partnership project (3GPP) NR physical layer design for multiple input multiple output (MIMO) enhancements in Release-18 and beyond. More specifically, some embodiments provide enhanced UE procedures for simultaneous uplink transmission of multi-panel UEs (MP-UEs). In the present disclosure, antenna panels (or panels) and antenna groups (or antenna panel and antenna group) may be used interchangeably, for example if antenna panel or antenna panels is used, it may also indicate antenna group or antenna groups accordingly. In order to make the description simple, it will not be elaborated redundantly.

As mentioned above, enhancements on MP-UEs are still needed. Specifically, the terminal device may be provided with two or more joint or UL transmission configuration indicator (TCI) states based on which the terminal device would perform a multi-panel UL transmission. In a real operating scenario the distance and radio conditions between the transmitting panels of the terminal device and the receiving terminal devices may differ quite much. For the UL transmission, an open loop power control may be applied that aims at compensating the higher path loss by the higher transmission power. Thus, the panels transmitting simultaneously may have quite different effective isotropic radiated power (EIRP) per resource element/subcarrier. Even though the (main lobes of) transmit beams may be spatially separated, the panel with higher EIRP may have sidelobes in the same level as the main lobe of the transmit beam of another panel with lower EIRP. The panel with higher EIRP might induce high interference with its side lobes to the receiving terminal device of another panel with lower EIRP.

It has been agreed in 3GPP that a solution for facilitating multi-panel UL transmission for higher UL throughput/reliability needs to be studied, and if needed, specified. Therefore, there is a need to develop enhanced UE procedures for determining schemes for simultaneous UL multi-panel transmission with higher reliability and higher UL throughput.

According to embodiments of the present disclosure, there is providing a solution for scheme determination for simultaneous UL multi-panel transmission. In this solution, a terminal device obtains at least one measurement value of a reference signal over two or more antenna groups of the terminal device. The terminal device reports an indication to a network device based on the measurement value, wherein the indication indicates at least one uplink transmission scheme that can be used. As such, the terminal device can determine a transmission scheme based on the measurement over antenna groups, thereby enabling simultaneous UL multi-panel transmission with less inter-beam interference.

Principle and embodiments of the present disclosure will be described in detail below with reference to the accompanying drawings. However, it is to be noted that these embodiments are illustrated as examples and not intended to limit scope of the present application in any way.

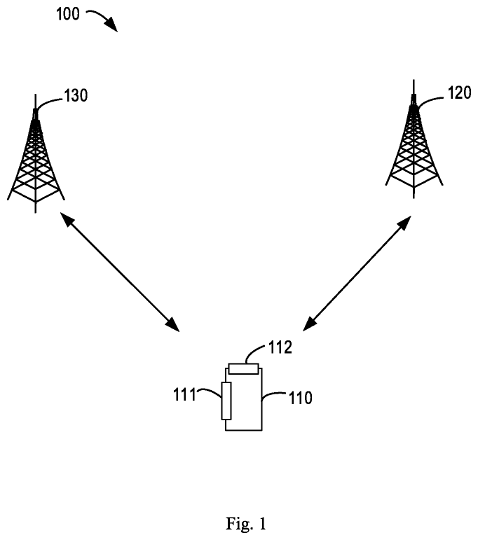

Reference is first made to FIG. 1, which illustrates an example communication system 100 in which embodiments of the present disclosure may be implemented. As illustrated in FIG. 1, the system 100 includes two network devices, such as network devices 120, 130. The network devices 120, 130 may each have one respective group of antenna ports. In other words, the network devices 120, 130 may be associated with or function as two respective TRPs, and thus sometimes they can be also referred to as TRP 12 and TRP 130 in the present disclosure. For clarity purposes, TRP 120 may be also referred to a first TRP, and TRP 130 may be also referred to a second TRP.

The network devices 120, 130 may each operate using different frequency bands in both DL and UL. In communication systems, “UL” refers to a communication link in a direction from a terminal device to a network device, and “DL” refers to a communication link in a direction from the network device to the terminal device.

The system 100 also includes one or more terminal devices, such as terminal device 110. The terminal device 110 are capable of connecting, for example wirelessly, and communicating in an UL and DL with either or both of the network devices 120, 130 depending on location of the terminal devices in the cells of the network devices 120, 130. The terminal device 110 may be configured to be communicated with network via one or more TRPs, for example 2 TRPs. The two TRPs may be located within the same cell (intra-cell TRP) or within different cells (inter-cell TRP).

The terminal device 110 may be a MP-UE comprising a plurality of panels. From a wireless communication perspective, a MP-UE may comprise any device having a plurality of antenna groups configured as a panel. The MP-UE may provide flexibility in selecting antennas for wireless communication. In an aspect, although multiple panels of the MP-UE may be active, one panel may be selected for uplink transmission using a single beam. In other aspects, multiple beams may be transmitted simultaneously from multiple panels.

The terminal device 110 in FIG. 1 may comprise include a plurality of panels, such as a first panel 111, a second panel 112, and additional optional panels (not shown) if necessary. In general, a panel may be a UE component that includes one or more antenna group. The antenna group may comprise one or more antennas, antenna elements and/or antenna arrays. Each panel may operate independently to some extent. For example, each panel may be individually activated or deactivated. The activated panel may be used for transmission and/or reception, while the disabled panel may not be used for transmission and/or reception. The panels may be elements of an antenna group that independently control beams. For example, within the panel, one beam may be selected and used for UL transmission. In addition, multiple panels may be used for UL transmission, and multiple beams (each beam selected per panel) may be used for UL transmission across different panels.

It is to be understood that in FIG. 1, the number of network devices, terminal devices is only for the purpose of illustration without suggesting any limitations. Moreover, the number of panels of a terminal device is also given only for the purpose of illustration. The system 100 may include any suitable number of network devices and terminal devices and a terminal device may include any suitable number of panels, as long as the number could be adapted for implementing embodiments of the present disclosure.

Communications in the communication system 100 may be implemented according to any proper communication protocol(s), comprising, but not limited to, cellular communication protocols of the third generation (3G), the fourth generation (4G) and the fifth generation (5G) or beyond, wireless local network communication protocols such as institute for electrical and electronics engineers (IEEE) 802.11 and the like, and/or any other protocols currently known or to be developed in the future. Moreover, the communication may utilize any proper wireless communication technology, comprising but not limited to: code division multiple access (CDMA), frequency division multiple access (FDMA), time division multiple access (TDMA), frequency division duplex (FDD), time division duplex (TDD), multiple-input multiple-output (MIMO), orthogonal frequency division multiple (OFDM), discrete fourier transform spread OFDM (DFT-s-OFDM) and/or any other technologies currently known or to be developed in the future.

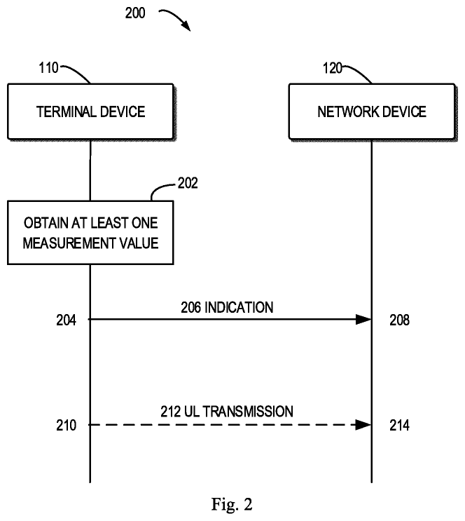

Reference is now made to FIG. 2, which shows an example of a process 200 for the scheme determination for UL multi-panel transmission according to some embodiments of the present disclosure. For the purpose of discussion, the process 200 will be described with reference to FIG. 1. The network device 120 and the terminal device 110 may be involved in the process 200 for the purpose of illustration.

In the process 200, a terminal device 110 obtains 202 at least one measurement value of a reference signal over two or more antenna groups of the terminal device 110. The two or more antenna groups of the terminal device 110 may include, for example, an antenna group in the first panel 111 and an antenna group in the second panel 112 which may be configured to perform transmission and/or reception simultaneously. The reference signal may comprise a downlink reference signal or an uplink reference signal. The downlink reference signal may include e.g., channel state information reference signal (CSI-RS)). The uplink reference signal may include e.g., sounding reference signal (SRS). Measurements of the reference signal over the two or more antenna groups may be performed in various manners and will be described in detail below. Based on the measurement, the terminal device may be able to determine a proper transmission scheme for the multi-panel uplink transmission of the two or more antenna groups with higher reliability and/or higher UL throughputs.

The terminal device 110 then reports 204 an indication 206 to a network device 120 based on the measurement value. The indication 206 indicates at least one uplink transmission scheme that can be used. The network device 120 receives 208 the indication 206. In some embodiments, the terminal device 110 may transmit 210 an uplink transmission 212 to the network device 120 using the uplink transmission scheme indicated by the indication 206. The network device 120 receives 214 the uplink transmission 212 from the terminal device 110 using the uplink transmission scheme indicated by the indication 206. For example, the terminal device 110 may determine, a inference level based on the measurement of the reference signal over the two antenna groups. For example, it may determine whether a transmission beam on one antenna group would influence a transmission beam on another antenna group, thereby causing high interference to the receiving TRP associated with the another beam. Based on the determination, the terminal device may select a suitable uplink transmission scheme that can be used for the two antenna groups. In this way, UL multi-panel transmission may be achieved with higher reliability and higher UL throughput.

In some embodiments, the reference signal may comprise a downlink reference signal. The at least one measurement value may comprise a measurement difference between the downlink reference signal over the two or more antenna groups. In some embodiments, the measurement difference may comprise a first measurement difference between a first measurement and a second measurement. The first measurement may comprise a measurement of a first downlink reference signal associated with a first of the two or more antenna groups over the first antenna group. The second measurement may comprise a measurement of the first downlink reference signal over a second of the two or more antenna groups. In this way, an interference level from the first antenna group to the second antenna group may be determined based on the first measurement difference of the first reference signal over the first and second antenna groups.

Alternatively or additionally, the measurement difference may comprise a second measurement difference between a third measurement and a fourth measurement. The third measurement may comprise a measurement of a second downlink reference signal associated with the second antenna group over the second antenna group. The fourth measurement comprises a measurement of the second downlink reference signal over the first antenna group. In this way, an interference level from the second antenna group to the first antenna group may be determined based on the second measurement difference of the second reference signal over the first and second antenna groups. Interference level between each of the two or more antenna groups may be obtained in a similar way.

In some embodiments, both the first measurement difference and the second measurement difference are determined. The interference level may be determined based on the first and second measurement difference.

In some embodiments, the reference signal may comprise an uplink reference signal. The at least one measurement value may comprise one or more measurement values of the uplink reference signal transmitted by at least one of the two or more antenna groups other than the antenna group on which the one or more measurement values are measured. In some embodiments, the one or more measurement values of the uplink reference signal may comprise a first measurement value of an interference level of a second uplink reference signal transmitted from a second antenna group of the two or more antenna groups to a first antenna group of two or more antenna groups. In this way, an interference level from the second antenna group transmitting the second uplink reference signal to the first antenna group measuring the second uplink reference signal may be determined.

Alternatively or additionally, the one or more measurement values of the uplink reference signal may comprise a second measurement value of an interference level of a first uplink reference signal transmitted from the first antenna group to the second antenna group. In this way, an interference level from the first antenna group transmitting the first uplink reference signal to the second antenna group measuring the first uplink reference signal may be determined. In some embodiments, the interference level may be determined based on a comparison of the measurement value of the uplink reference signal to the transmission power of the uplink reference signal or to an uplink transmission power of the another antenna group measuring the uplink reference signal.

In some embodiments, the indication 206 may be determined based on the measurement value and a threshold for determining the uplink transmission scheme. In some embodiments, the threshold may be configured by the network device or predefined. The network device 120 may configure a threshold for determining the uplink transmission scheme for the terminal device.

In some embodiments, the indication 206 may be determined to indicate a first type of uplink transmission scheme based on a determination that the measurement value is below a first threshold. Alternatively or additionally, the indication 206 may be determined to indicate a second type of uplink transmission scheme based on a determination that the measurement value is not below the first threshold. In this way, the first type of the uplink transmission scheme may be selected when there is no interference issue and the second type of uplink transmission scheme may be selected to avoid interference issue.

In some embodiments, the first type of the uplink transmission scheme may comprise a first scheme in which different layers or demodulation reference signal (DM-RS) ports of a physical uplink shared channel (PUSCH) are separately precoded and transmitted from different antenna groups simultaneously. The first scheme may also be referred to as a spatial domain multiplexing (SDM) scheme. Alternatively or additionally, the first type of the uplink transmission scheme may comprise a second scheme in which at different PUSCH transmission occasions different redundancy versions (RV) of the same transport block (TB) are transmitted from different antenna groups. The second scheme may also be referred to as a spatial domain repetition scheme. In this way, higher UL throughput may be achieved in multi-panel UL transmission.

In some embodiments, the second type of the uplink transmission scheme may comprise a third scheme in which a same PUSCH or DM-RS is transmitted from different antenna groups using different transmission configuration indicator (TCI) states. The third scheme may also be referred to as a single frequency transmission-based (SFN-based) scheme. Alternatively or additionally, the second type of the uplink transmission scheme may comprise a fourth scheme in which at a same PUSCH transmission occasion, a same PUSCH is transmitted from different antenna groups using different parts of frequency domain resource. The fourth scheme may also be referred to as a frequency domain multiplexing-A (FDM-A) scheme. Alternatively or additionally, the second type of the uplink transmission scheme may comprise a fifth scheme in which different PUSCH repetitions with same/different RV of the same TB are performed from different antenna groups on non-overlapped frequency domain resources. The fourth scheme may also be referred to as a FDM-B scheme. In this way, higher reliability may be ensured in multi-panel UL transmission.

A more specific example of determining the multi-panel UL transmission scheme of the terminal device 110 may be described in detail. In an embodiment, the terminal device 110 may comprise the first panel 111 and the second panel 112. The terminal device 110 may be configured to report the interference determinations and one or more downlink reference signal (DL RS) pairs. Two reference signals may be downlink reference signal such as CSI-RS. The two reference signals are associated with the first panel 111 and the second panel 112, respectively. The terminal device 110 may measure the DL RS resource associated with a (first) candidate TCI state using one panel (e.g., the first panel 111) to obtain a first measurement quantity. The uplink transmit beam may be represented by a logical entity index. The first measurement quantity may be for example a layer-1 reference signal receiving power (L1-RSRP) measurement and may be referred to as a measurement #1.

The terminal device 110 may further measure the DL RS resource associated with a (second) candidate TCI state using one panel (e.g., the first panel 111) to obtain a second measurement quantity. The uplink transmit beam may be represented by a logical entity index. The second measurement quantity may be for example a layer-1 reference signal receiving power (L1-RSRP) measurement and may be referred to as a measurement #2.

The terminal device 110 may measure the DL RS resource of the (second) candidate TCI state using the other panel (e.g., the second panel 112) to obtain a third measurement quantity. The third measurement quantity may be, for example, a layer-1 reference signal receiving power (L1-RSRP) measurement and may be referred to as a measurement #3.

The terminal device 110 may measure the DL RS resource of the (first) candidate TCI state using the other panel (e.g., the second panel 112) to obtain a fourth measurement quantity. The fourth measurement quantity may be for example a layer-1 reference signal receiving power (L1-RSRP) measurement and may be referred to as a measurement #4.

In order to perform interference determination and resource/TCI-state selection, the terminal device 110 may compare the measurement #2 with measurement #3. If the measurement #2 and measurement #3 are in a substantially similar power level (e.g. their difference is within some predetermined amount of dBs), the terminal device 110 may determine an inter-panel interference issue from the first panel 111 to the second panel 112 at the receiving TRP associated with the second TCI state. The comparison and determination step may be performed in terms of pathloss values #2 and #3 corresponding to measurements #2 and #3, respectively, or performed in terms of 1/measurement #x (x=2 or 3). The comparison result of measurement #2 and measurement #3 may have several levels which may be in turn associated with the simultaneous transmission modes. If the difference between the measurement #3 and the measurement #2 is larger than a predetermined level #0, the terminal device 110 may determine that both the first type and the second type of transmission schemes are feasible. If the difference between the measurement #3 and the measurement #2 is smaller than the predetermined level #0 but higher than a predetermined level #1, the terminal device 110 may determine that the fourth and fifth schemes among the second type of transmission schemes are feasible. If the difference between the measurement #3 and the measurement #2 is smaller than the predetermined level #1 but higher than a predetermined level #2, the terminal device 110 may determine that the fifth scheme among the second type of transmission schemes is feasible. If the difference between the measurement #3 and the measurement #2 is smaller than the predetermined level #2, the terminal device 110 may determine that none of transmission schemes for multi-panel UL transmission is feasible and a time division multiplexing (TDM) scheme can be used for the panels 111 and 112.

Similarly, the terminal device 110 may then compare the measurement #1 with measurement #4. If the measurement #1 and measurement #4 are in a substantially similar power level (e.g. their difference is within some predetermined amount of dBs), the terminal device 110 may determine an inter-panel interference issue from the second panel 112 to the first panel 111 at the receiving TRP associated with the first TCI state. The comparison and determination step may be performed in terms of pathloss values #1 and #4 corresponding to measurements #1 and #4, respectively, or performed in terms of 1/measurement #x (x=1 or 4). The comparison result of measurement #1 and measurement #4 may have several levels which may be in turn associated with the simultaneous transmission modes. If the difference between the measurement #1 and the measurement #4 is larger than a predetermined level #0, the terminal device 110 may determine that both the first type and the second type of transmission schemes are feasible. If the difference between the measurement #1 and the measurement #4 is smaller than the predetermined level #0 but higher than a predetermined level #1, the terminal device 110 may determine that the fourth and fifth schemes among the second type of transmission schemes are feasible. If the difference between the measurement #1 and the measurement #4 is smaller than the predetermined level #1 but higher than a predetermined level #2, the terminal device 110 may determine that the fifth scheme among the second type of transmission schemes is feasible. If the difference between the measurement #1 and the measurement #4 is smaller than the predetermined level #2, the terminal device 110 may determine that none of transmission schemes for multi-panel UL transmission is feasible and a TDM scheme can be used for the panels 111 and 112.

Alternatively, the reporting of the indication may be configured to be specific to uplink simultaneous TX mode or include the configured UL simultaneous TX modes. In other words, reporting may be provided separately for each TX mode or one report may include separately the indication for each configured TX mode.

In some embodiments, the terminal device 110 may provide to the network device 120 with beam information indicating available beams for the uplink transmission scheme.

In some embodiments, the beam information may be contained with the indication 206 or reported independently.

In some embodiments, the beam information may comprise two or more reference signals. Alternatively of additionally, the beam information may comprise two or more TCI states. Alternatively of additionally, the beam information may comprise two or more beams each having a lowest interference level from other beams. Alternatively of additionally, the beam information may comprise two or more beams each having a highest interference level from other beams. Alternatively of additionally, the beam information may comprise pairs of beam. Each pair may include one beam of two or more best beam and another beam of the two or more beams having a lowest interference to other beams. Alternatively of additionally, the beam information may comprise pairs of beam. Each pair may include one beam of two or more best beams, and another beam of the two or more best beams having a highest interference to other beams.

For example, when providing the interference determination results to the network device 120, the terminal device 110 may provide the pair of RSs or TCIs (best beams or current indicated beams) and indication whether or not the first type of scheme would be feasible based on the determination above.

Alternatively, for each of the reported N (best) beams: the terminal device 110 may rank and report lowest (/highest) ‘interference’ level from the other beams corresponding to other panels, and the corresponding beam and/or panel.

Alternatively, the terminal device 110 may report pairs of beams, where each pair may consist of: one of N (best) beams, and a weakest/strongest beam (from another panel, from the N−1 best beams) from interference level perspective.

Alternatively, the terminal device 110 may report a recommended scheme(s) (codepoint) in priorized order based on a set of predefined set of schemes. The number of reported recommended schemes may be configured by the terminal device 110.

In some embodiments, the scheme determination step may be performed by the network device 120. The terminal device 110 may transmit the measurement results to the network device 120. The network device 120 may determine the transmission scheme for simultaneous UL multi-panel transmission of the one or more antenna groups of the terminal device 110. The terminal device 110 may perform simultaneous UL multi-panel transmission using the transmission scheme indicated by the network device 120. In other words, the scheme determination may be network-controlled. In some embodiments, the network device 120 may also use the reported information to select between TDM, FDM and SDM transmission schemes.

In some embodiments, the network device 120 may provide the terminal device 110 with the TCI states for the both transmitting panels where each TCI state includes DL RS based on which the terminal device 110 determines the transmit beam per panel. The network device 120 may configure the terminal device 110 to measure and report the feasibility of the first type of uplink transmission scheme in simultaneous transmission scheme. The network device 120 may transmit DL RSs to the terminal device 110. The network device 120 may receive the report from the terminal device 110. If the network device 120 reads from the report that there may be interference issue from one panel to the other panel at the receiver the network device 120 may configure/schedule/trigger simultaneous transmission from two panels using the second type of uplink transmission scheme; otherwise the gNB may configure/schedule/trigger simultaneous transmission from two panels using the first type of uplink transmission scheme. In the comparing and determination step about whether SDM scheme would suffer from potential interference issue, the network device 120 may provide the threshold in dB that is used to compare the measurements.

Considering possible inter-beam interference issue and how it could be estimated before triggering the actual simultaneous uplink for example PUSCH transmissions, embodiments of the present disclosure enable the network device to choose RSs for reporting as potential source RSs to determine uplink transmit spatial filters and to estimate cross-link/beam interference by each panel by measuring the RS candidate for the other panel to determine the uplink transmit beam.

With example embodiments of the present disclosure, the network device could get aware of the network situation so that it could make a proper transmission scheme selection for the multi-panel uplink transmission. Compared to the network-controlled embodiments, the implementation of UE-controlled scheme determination may be more adaptive especially to different scenarios where the transmission scheme selection is more semi-static and scenarios where one panel may be having configuration for configured grant PUSCH transmissions.

The described measurement, comparison, interference issue determination steps and reporting step in the previous embodiments may be incorporated e.g. into L1-RSRP measurement and reporting functionality, or into capability value index reporting, or in general into CSI reporting in TS 38.214. In some embodiments, the reporting may be periodic, semi-persistent or aperiodic. Similarly, DL RSs to be measured may be periodic, semi-persistent or aperiodic.

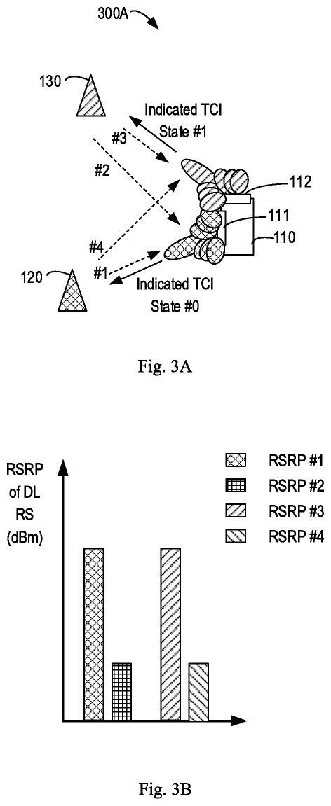

Reference is now made to FIGS. 3A-3F to illustrate different cases related to uplink transmission from two panels. FIG. 3A illustrates a first example scenario 300A of multi-panel UL transmission in the example communication network 100 in FIG. 1. As shown in FIG. 3A, the terminal device 110 may have the first panel 111 and the second panel 112. Each panel may comprise at least an antenna port. The terminal device 110 may be provided with two joint or UL TCI states. A TCI state may be associated with a reference signal (downlink and/or uplink) based on which the terminal device 110 may set its transmit spatial filter(s) (i.e. TX beam(s)) for the transmission. The first panel 111 may receive a first DL RS from the first TRP 120 with a first TCI state, or transmit a UL RS to the first TRP 120.

The second panel 112 may receive a second DL RS from the second TRP 130 with a second TCI state, or transmit a UL RS to the second TRP 130. In order to determine a suitable transmission scheme for the multi-panel UL transmission (illustrated in solid lines), the first and second DL RS from TRP 120 and 130 are measured respectively at panel 111 and panel 112, as illustrated in dashed lines.

FIG. 3B illustrates an example diagram of RSRP results based on measurements of e.g. DL reference signals in the example transmission in FIG. 3A. RSRP #1 indicates the measured RSRP result of the first DL RS at panel 111, wherein the first DL RS represents the QCL source (TRP 120) in the TCI state #0 defining the uplink beam of the first panel 111 (panel 111 associated with TCI state #0). RSRP #2 indicates the measured RSRP value of the second DL RS at panel 111. RSRP #3 indicates the measured RSRP result of the second DL RS at panel 112, wherein the second DL RS representing the QCL source (TRP 130) in the TCI state #1 defining the uplink beam of the second panel 112. RSRP #4 indicates the measured RSRP value of the first DL RS of at panel 112.

As shown in FIG. 3A, the distances and radio conditions between panel 111 and TRP 120 and between the panel 112 and TRP 130 may be similar. EIRP per resource element for the two panels are in a similar level and the transmission beams are spatially separated. As further indicated in FIG. 3B, both differences between RSPP #1 and RSRP #4 and the difference between RSRP #2 and RSRP 3 is large, which mean a lower interference level between UL transmissions. In such a case, the terminal device 110 may thus determine that an UL multi-panel transmission may be performed with any of the SDM scheme, the spatial domain repetition scheme, the SFN-based scheme, the FDM-A scheme or the FDM-B scheme.

FIG. 3C illustrates a second example scenario 300B of multi-panel UL transmission and FIG. 3D illustrates an example diagram of RSRP results based on measurements of DL reference signals in the example transmission in FIG. 3C. As shown in FIGS. 3C, the distances and radio conditions between panel 111 and TRP 120 and between the panel 112 and TRP 130 may differ quite much. EIRP per resource element for the two panels are in different levels. Even though the (main lobes of) transmit beams may be spatially separated, the panel 112 with higher EIRP may have sidelobes in the same level as the main lobe of the transmit beam of the other panel 111. As shown in FIG. 3C, sidelobes of the beam of the panel 112 might cause significant interference to the TRP 120 of the other panel 110 with lower EIRP. As further shown in FIG. 3D, the RSRP #1 is in the same level as the RSRP #4, indicating an unreliable scenario from a point of view of SDM scheme. In such a case, the terminal device 110 may thus determine that an UL multi-panel transmission may be performed with the SFN-based scheme, the FDM-A scheme or the FDM-B scheme.

FIG. 3E illustrates a third example scenario 300C of multi-panel UL transmission and FIG. 3F illustrates an example diagram of RSRP results based on measurements of DL reference signals in the example transmission in FIG. 3E. As shown in FIGS. 3E, the distances and radio conditions between the panel 111 and TRP 120 and between the panel 112 and TRP 130 may differ quite much. EIRP per resource element for the two panels are in different levels. Since the (main lobes of) transmit beams are spatially separated in a large scale, the panel 112 with higher EIRP may have sidelobes in the same level as the main lobe of the transmit beam of the other panel 111. As shown in FIG. 3E, sidelobes of the beam of the panel 112 would not significant interference to the receiving TRP 120 of the other panel 110 with lower EIRP. As further shown in FIG. 3F, both differences between RSPP #1 and RSRP #4 and the difference between RSRP #2 and RSRP 3 is large, which may mean a lower interference level between UL transmissions. In such a case, the terminal device 110 may thus determine that an UL multi-panel transmission may be performed with any of the SDM scheme, the spatial domain repetition scheme, the SFN-based scheme, the FDM-A scheme or the FDM-B scheme.

Please be noted that the inference level may also be determined based on measurement of the UL RS in a similar way, and for purposes of simplification, details will not be provided herein.

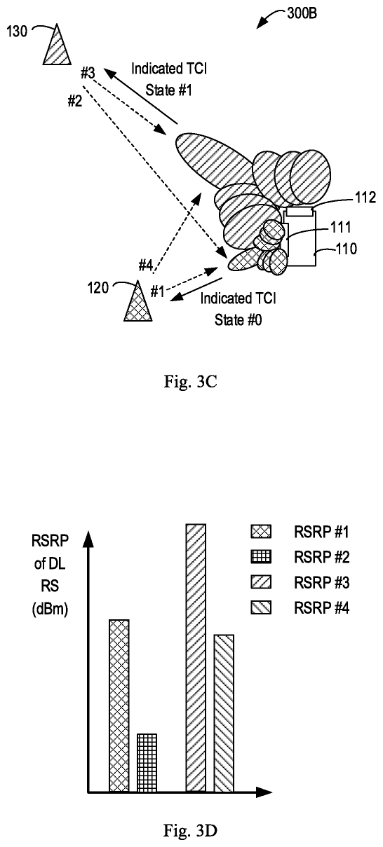

FIG. 4 shows a flowchart of an example method 400 implemented at a terminal device in accordance with some embodiments of the present disclosure. For the purpose of discussion, the method 400 will be described from the perspective of the terminal device 110 with reference to FIG. 1.

At block 420, the terminal device 110 obtains at least one measurement value of a reference signal over two or more antenna groups of the terminal device. At block 440, the terminal device 110 report an indication to a network device based on the measurement value, wherein the indication indicates at least one uplink transmission scheme that can be used.

In some embodiments, the reference signal may comprise a downlink reference signal. The at least one measurement value may comprise a measurement difference between the downlink reference signal over the two or more antenna groups.

In some embodiments, the measurement difference may comprise one or both of: a first measurement difference between a first measurement and a second measurement, wherein the first measurement comprises a measurement of a first downlink reference signal associated with a first of the two or more antenna groups over the first antenna group, and the second measurement comprises a measurement of the first downlink reference signal over a second of the two or more antenna groups; or a second measurement difference between a third measurement and a fourth measurement, wherein the third measurement comprises a measurement of a second downlink reference signal associated with the second antenna group over the second antenna group, and the fourth measurement comprises a measurement of the second downlink reference signal over the first antenna group.

In some embodiments, the reference signal may comprise an uplink reference signal.

The at least one measurement value may comprise one or more measurement values of the uplink reference signal transmitted by at least one of the two or more antenna groups other than the antenna group on which the one or more measurement values are measured.

In some embodiments, the one or more measurement values of the uplink reference signal may comprise one or both of: a first measurement value of an interference level of a second uplink reference signal transmitted from a second antenna group of the two or more antenna groups to a first antenna group of two or more antenna groups, or a second measurement value of an interference level of a first uplink reference signal transmitted from the first antenna group to the second antenna group.

In some embodiments, the indication may be determined based on the measurement value and a threshold for determining the uplink transmission scheme. In some embodiments, the threshold may be configured by the network device 120.

In some embodiments, the indication may be determined to indicate a first type of uplink transmission scheme based on a determination that the measurement value is below a first threshold; or wherein the indication may be determined to indicate a second type of uplink transmission scheme based on a determination that the measurement value is not below the first threshold.

In some embodiments, the first type of the uplink transmission scheme may comprise one or more of: a first scheme in which different layers or demodulation reference signal, DM-RS, ports of a physical uplink shared channel, PUSCH, are separately precoded and transmitted from different antenna groups simultaneously; or a second scheme in which at different PUSCH transmission occasions different redundancy versions, RV, of the same transport block, TB, are transmitted from different antenna groups.

In some embodiments, the second type of the uplink transmission scheme may comprise one or more of: a third scheme in which a same PUSCH or DM-RS is transmitted from different antenna groups using different transmission configuration indicator, TCI, states; a fourth scheme in which at a same PUSCH transmission occasion, a same PUSCH is transmitted from different antenna groups using different parts of frequency domain resource; or a fifth scheme in which different PUSCH repetitions with same/different RV of the same TB are performed from different antenna groups on non-overlapped frequency domain resources.

In some embodiments, the terminal device 110 may further transmit, to the network device 120, an uplink transmission using the uplink transmission scheme indicated by the indication.

In some embodiments, the terminal device is may further provide to the network device 120, beam information indicating available beams for the uplink transmission scheme.

In some embodiments, the beam information may comprise one or more of: two or more reference signals; two or more TCI states; two or more beams each having a lowest interference level from other beams; two or more beams each having a highest interference level from other beams; pairs of beam each pair including one beam of two or more best beam and another beam of the two or more beams having a lowest interference to other beams; or pairs of beam wherein each pair including one beam of two or more best beams, and another beam of the two or more best beams having a highest interference to other beams.

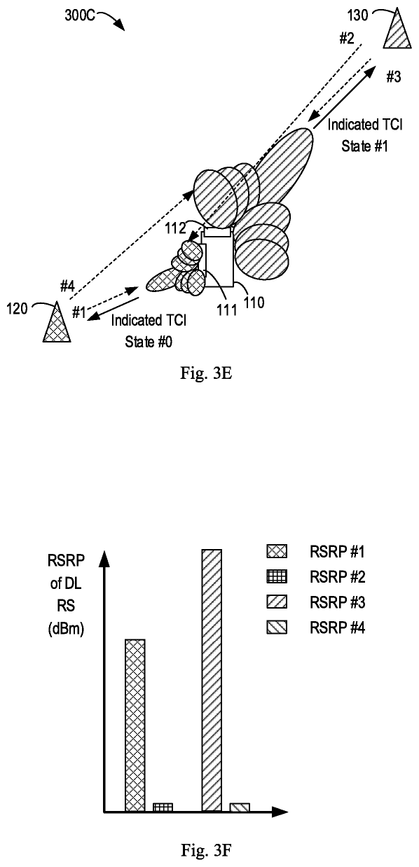

FIG. 5 shows a flowchart of an example method 500 implemented at a network device in accordance with some embodiments of the present disclosure. For the purpose of discussion, the method 500 will be described from the perspective of the network device 120 with reference to FIG. 1.

At block 520, the network device 120 obtains an indication from a terminal device, wherein the indication indicates at least one uplink transmission scheme that can be used for two or more antenna groups. At block540, the network device 120 receives, from the terminal device 110, an uplink transmission using the uplink transmission scheme indicated by the indication.

In some embodiments, the network device 120 may further configure a threshold for determining the uplink transmission scheme for the terminal device.

In some embodiments, the indication may comprise a first type of uplink transmission scheme; or the indication may comprise a second type of uplink transmission scheme.

In some embodiments, the first type of the uplink transmission scheme may comprise one or more of: a first scheme in which different layers or demodulation reference signal, DM-RS, ports of a physical uplink shared channel, PUSCH, are separately precoded from different antenna groups simultaneously; or a second scheme in which at different PUSCH transmission occasions different redundancy versions, RV, of the same transport block, TB, are transmitted from different antenna groups.

In some embodiments, the second type of the uplink transmission scheme comprises one or more of: a third scheme in which a same PUSCH or DM-RS is transmitted from different antenna groups using different transmission configuration indicator, TCI, states; a fourth scheme in which at a same PUSCH transmission occasion, a same PUSCH is transmitted from different antenna groups using different parts of frequency domain resource; or a fifth scheme in which different PUSCH repetitions with same/different RV of the same

TB are performed from different antenna groups on non-overlapped frequency domain resources.

In some embodiments, the network device 120 may further obtain, from the terminal device 110, beam information indicating available beams for the uplink transmission scheme. In some embodiments, the beam information may comprise one or more of: two or

more reference signals; two or more TCI states; two or more beams each having a lowest interference level from other beams; two or more beams each having a highest interference level from other beams; pairs of beam each pair including one beam of two or more best beam and another beam of the two or more beams having a lowest interference to other beams; or pairs of beam each pair including one beam of two or more best beams, and another beam of the two or more best beams having a highest interference to other beams.

In some embodiments, an apparatus capable of performing any of the method 400 (for example, the terminal device 110) may comprise means for performing the respective steps of the method 400. The means may be implemented in any suitable form. For example, the means may be implemented in a circuitry or software module.

In some embodiments, the apparatus comprises: means for obtaining, at a terminal device, at least one measurement value of a reference signal over two or more antenna groups of a terminal device; and means for reporting an indication to a network device based on the measurement value, wherein the indication indicates at least one uplink transmission scheme that can be used.

In some embodiments, the reference signal may comprise a downlink reference signal. The at least one measurement value may comprise a measurement difference between the downlink reference signal over the two or more antenna groups.

In some embodiments, the measurement difference may comprise one or both of: a first measurement difference between a first measurement and a second measurement, wherein the first measurement comprises a measurement of a first downlink reference signal associated with a first of the two or more antenna groups over the first antenna group, and the second measurement comprises a measurement of the first downlink reference signal over a second of the two or more antenna groups; or a second measurement difference between a third measurement and a fourth measurement, wherein the third measurement comprises a measurement of a second downlink reference signal associated with the second antenna group over the second antenna group, and the fourth measurement comprises a measurement of the second downlink reference signal over the first antenna group.

In some embodiments, the reference signal may comprise an uplink reference signal. The at least one measurement value may comprise one or more measurement values of the uplink reference signal transmitted by at least one of the two or more antenna groups other than the antenna group on which the one or more measurement values are measured.

In some embodiments, the one or more measurement values of the uplink reference signal may comprise one or both of: a first measurement value of an interference level of a second uplink reference signal transmitted from a second antenna group of the two or more antenna groups to a first antenna group of two or more antenna groups, or a second measurement value of an interference level of a first uplink reference signal transmitted from the first antenna group to the second antenna group.

In some embodiments, the indication may be determined based on the measurement value and a threshold for determining the uplink transmission scheme. In some embodiments, the threshold may be configured by the network device 120.

In some embodiments, the indication may be determined to indicate a first type of uplink transmission scheme based on a determination that the measurement value is below a first threshold; or wherein the indication may be determined to indicate a second type of uplink transmission scheme based on a determination that the measurement value is not below the first threshold.

In some embodiments, the first type of the uplink transmission scheme may comprise one or more of: a first scheme in which different layers or demodulation reference signal, DM-RS, ports of a physical uplink shared channel, PUSCH, are separately precoded and transmitted from different antenna groups simultaneously; or a second scheme in which at different PUSCH transmission occasions different redundancy versions, RV, of the same transport block, TB, are transmitted from different antenna groups.

In some embodiments, the second type of the uplink transmission scheme may comprise one or more of: a third scheme in which a same PUSCH or DM-RS is transmitted from different antenna groups using different transmission configuration indicator, TCI, states; a fourth scheme in which at a same PUSCH transmission occasion, a same PUSCH is transmitted from different antenna groups using different parts of frequency domain resource; or a fifth scheme in which different PUSCH repetitions with same/different RV of the same TB are performed from different antenna groups on non-overlapped frequency domain resources.

In some embodiments, the apparatus may further comprise means for transmitting, to the network device, an uplink transmission using the uplink transmission scheme indicated by the indication.

In some embodiments, the apparatus may further comprise means for providing to the network device, beam information indicating available beams for the uplink transmission scheme.

In some embodiments, the beam information may comprise one or more of: two or more reference signals; two or more TCI states; two or more beams each having a lowest interference level from other beams; two or more beams each having a highest interference level from other beams; pairs of beam each pair including one beam of two or more best beam and another beam of the two or more beams having a lowest interference to other beams; or pairs of beam wherein each pair including one beam of two or more best beams, and another beam of the two or more best beams having a highest interference to other beams.

In some embodiments, the apparatus further comprises means for performing other steps in some embodiments of the method 400. In some embodiments, the means comprises at least one processor; and at least one memory including computer program code, the at least one memory and computer program code configured to, with the at least one processor, cause the performance of the apparatus.

In some embodiments, an apparatus capable of performing any of the method 500 (for example, the network device 120) may comprise means for performing the respective steps of the method 500. The means may be implemented in any suitable form. For example, the means may be implemented in a circuitry or software module.

In some embodiments, the apparatus comprises: means for obtaining, at a network device, an indication from a terminal device, wherein the indication indicates at least one uplink transmission scheme that can be used for two or more antenna groups; and means for receiving, from the terminal device, an uplink transmission using the uplink transmission scheme indicated by the indication.

In some embodiments, the apparatus may further comprise means for configuring a threshold for determining the uplink transmission scheme for the terminal device.

In some embodiments, the indication may comprise a first type of uplink transmission scheme; or the indication may comprise a second type of uplink transmission scheme.

In some embodiments, the first type of the uplink transmission scheme may comprise one or more of: a first scheme in which different layers or demodulation reference signal, DM-RS, ports of a physical uplink shared channel, PUSCH, are separately precoded and transmitted from different antenna groups simultaneously; or a second scheme in which at different PUSCH transmission occasions different redundancy versions, RV, of the same transport block, TB, are transmitted from different antenna groups.

In some embodiments, the second type of the uplink transmission scheme comprises one or more of: a third scheme in which a same PUSCH or DM-RS is transmitted from different antenna groups using different transmission configuration indicator, TCI, states; a fourth scheme in which at a same PUSCH transmission occasion, a same PUSCH is transmitted from different antenna groups using different parts of frequency domain resource; or a fifth scheme in which different PUSCH repetitions with same/different RV of the same TB are performed from different antenna groups on non-overlapped frequency domain resources.

In some embodiments, the apparatus may further comprise means for obtaining, from the terminal device, beam information indicating available beams for the uplink transmission scheme.

In some embodiments, the beam information may comprise one or more of: two or more reference signals; two or more TCI states; two or more beams each having a lowest interference level from other beams; two or more beams each having a highest interference level from other beams; pairs of beam each pair including one beam of two or more best beam and another beam of the two or more beams having a lowest interference to other beams; or pairs of beam each pair including one beam of two or more best beams, and another beam of the two or more best beams having a highest interference to other beams.

In some embodiments, the apparatus further comprises means for performing other steps in some embodiments of the method 500. In some embodiments, the means comprises at least one processor; and at least one memory including computer program code, the at least one memory and computer program code configured to, with the at least one processor, cause the performance of the apparatus.

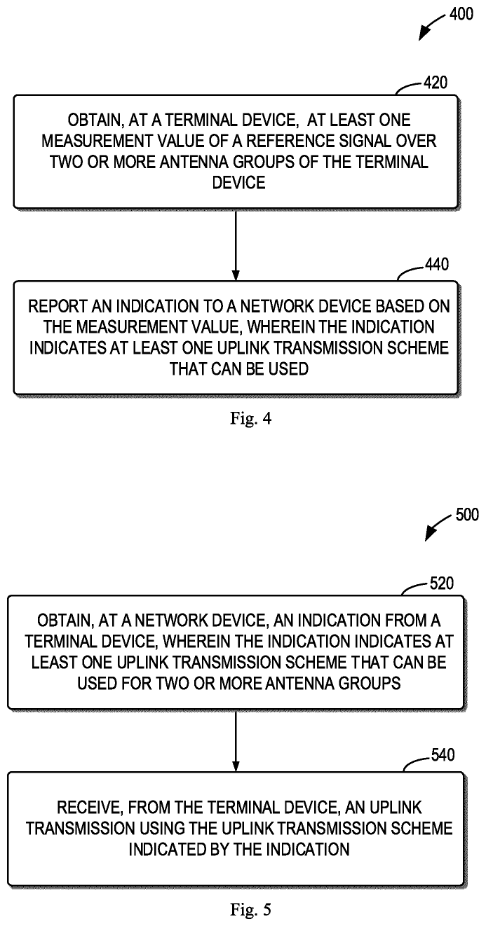

FIG. 6 is a simplified block diagram of a device 600 that is suitable for implementing embodiments of the present disclosure. The device 600 may be provided to implement the communication device, for example the terminal device 110, the terminal device 121, the network device 120 or the network device 130 as shown in FIG. 1. As shown, the device 600 includes one or more processors 610, one or more memories 640 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIGS. 2 to 5. The embodiments of the present disclosure may also be implemented by hardware or by a combination of software and hardware.

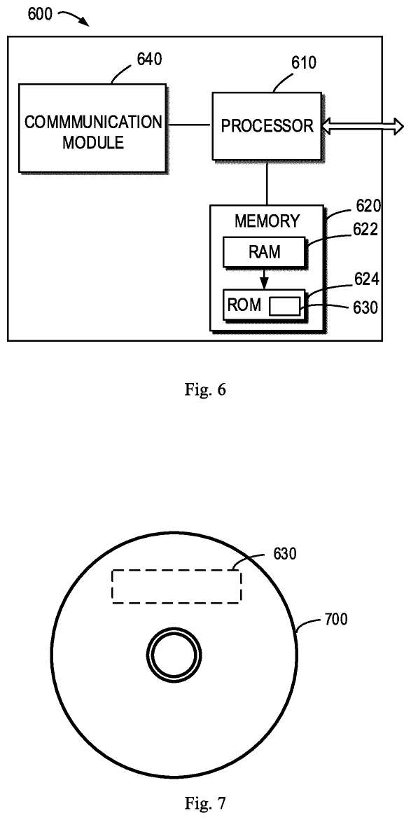

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 or 500 as described above with reference to FIGS. 2-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-27. (canceled)

28. A terminal device comprising:
one or more transceivers; and
one or more processors communicatively coupled to the one or more transceivers, wherein the one or more processors are configured to cause the terminal device to:
obtain a plurality of measurement values of a reference signal over two or more antenna groups of the terminal device, wherein the reference signal comprises a downlink reference signal, and wherein the plurality of measurement values comprises: a first measurement value with a measurement difference between the downlink reference signal over the two or more antenna group, a second measurement value of an interference level of a second uplink reference signal transmitted from a second antenna group of the two or more antenna groups to a first antenna group of two or more antenna groups, and a third measurement value of an interference level of a first uplink reference signal transmitted from the first antenna group to the second antenna group, wherein the measurement difference comprises:
a first measurement difference between a first measurement and a second measurement, wherein the first measurement comprises a measurement of a first downlink reference signal associated with a first of the two or more antenna groups over the first antenna group, and the second measurement comprises a measurement of the first downlink reference signal over a second of the two or more antenna groups; and
a second measurement difference between a third measurement and a fourth measurement, wherein the third measurement comprises a measurement of a second downlink reference signal associated with the second antenna group over the second antenna group, and the fourth measurement comprises a measurement of the second downlink reference signal over the first antenna group;
report an indication to a network device based on the measurement value, wherein the indication comprises a first type uplink transmission scheme that can be used; and
provide, to the network device, beam information indicating available beams for the first uplink transmission scheme, wherein the beam information comprises:
two or more reference signals;
two or more TCI states;
two or more beams each having a lowest interference level from other beams;
two or more beams each having a highest interference level from other beams;
pairs of beam each pair including one beam of two or more best beam and another beam of the two or more beams having a lowest interference to other beams; and
pairs of beam, wherein each pair includes one beam of two or more best beams, and another beam of the two or more best beams having a highest interference to other beams; and
wherein the indication further comprises a second type of uplink transmission scheme based on a determination that the measurement value is not below the first threshold, wherein the second type of the uplink transmission scheme comprises:
a third scheme in which a same physical uplink shared channel (PUSCH) or demodulation reference signal (DM-RS) is transmitted from different antenna groups using different transmission configuration indicator (TCI) states;
a fourth scheme in which at a same PUSCH transmission occasion, a same PUSCH is transmitted from different antenna groups using different parts of frequency domain resource; and
a fifth scheme in which different PUSCH repetitions with same/different RV of the same transport block (TB) are performed from different antenna groups on non-overlapped frequency domain resources.

29. The terminal device of claim 28, wherein the indication is determined based on the measurement value and a threshold for determining the uplink transmission scheme.

30. The terminal device of claim 29, wherein the threshold is configured by the network device.

31. The terminal device of claim 30, wherein the terminal device is further caused to:
transmit, to the network device, an uplink transmission using an uplink transmission scheme indicated by the indication.

32. A system comprising:
a terminal device;
one or more transceivers; and
one or more processors communicatively coupled to the one or more transceivers, wherein the one or more processors are configured to cause the terminal device to:
obtain a plurality of measurement values of a reference signal over two or more antenna groups of the terminal device, wherein the reference signal comprises a downlink reference signal, and wherein the plurality of measurement values comprises: a first measurement value with a measurement difference between the downlink reference signal over the two or more antenna group, a second measurement value of an interference level of a second uplink reference signal transmitted from a second antenna group of the two or more antenna groups to a first antenna group of two or more antenna groups, and a third measurement value of an interference level of a first uplink reference signal transmitted from the first antenna group to the second antenna group, wherein the measurement difference comprises:
a first measurement difference between a first measurement and a second measurement, wherein the first measurement comprises a measurement of a first downlink reference signal associated with a first of the two or more antenna groups over the first antenna group, and the second measurement comprises a measurement of the first downlink reference signal over a second of the two or more antenna groups; and
a second measurement difference between a third measurement and a fourth measurement, wherein the third measurement comprises a measurement of a second downlink reference signal associated with the second antenna group over the second antenna group, and the fourth measurement comprises a measurement of the second downlink reference signal over the first antenna group;
report an indication to a network device based on the measurement value, wherein the indication comprises a first type uplink transmission scheme that can be used; and
provide, to the network device, beam information indicating available beams for the first uplink transmission scheme, wherein the beam information comprises:
two or more reference signals;
two or more TCI states;
two or more beams each having a lowest interference level from other beams;
two or more beams each having a highest interference level from other beams;
pairs of beam each pair including one beam of two or more best beam and another beam of the two or more beams having a lowest interference to other beams; and
pairs of beam, wherein each pair includes one beam of two or more best beams, and another beam of the two or more best beams having a highest interference to other beams; and
wherein the indication further comprises a second type of uplink transmission scheme based on a determination that the measurement value is not below the first threshold, wherein the second type of the uplink transmission scheme comprises:
a third scheme in which a same physical uplink shared channel (PUSCH) or demodulation reference signal (DM-RS) is transmitted from different antenna groups using different transmission configuration indicator (TCI) states;
a fourth scheme in which at a same PUSCH transmission occasion, a same PUSCH is transmitted from different antenna groups using different parts of frequency domain resource; and
a fifth scheme in which different PUSCH repetitions with same/different RV of the same transport block (TB) are performed from different antenna groups on non-overlapped frequency domain resources.

33. The system of claim 32, wherein the indication is determined based on the measurement value and a threshold for determining the uplink transmission scheme.

34. The system of claim 33, wherein the threshold is configured by the network device.

35. The system of claim 34, wherein the terminal device is further caused to:
transmit, to the network device, an uplink transmission using an uplink transmission scheme indicated by the indication.

36. A method comprising:
obtaining, by a terminal device, a plurality of measurement values of a reference signal over two or more antenna groups of the terminal device, wherein the reference signal comprises a downlink reference signal, and wherein the plurality of measurement values comprises: a first measurement value with a measurement difference between the downlink reference signal over the two or more antenna group, a second measurement value of an interference level of a second uplink reference signal transmitted from a second antenna group of the two or more antenna groups to a first antenna group of two or more antenna groups, and a third measurement value of an interference level of a first uplink reference signal transmitted from the first antenna group to the second antenna group, wherein the measurement difference comprises:
a first measurement difference between a first measurement and a second measurement, wherein the first measurement comprises a measurement of a first downlink reference signal associated with a first of the two or more antenna groups over the first antenna group, and the second measurement comprises a measurement of the first downlink reference signal over a second of the two or more antenna groups; and
a second measurement difference between a third measurement and a fourth measurement, wherein the third measurement comprises a measurement of a second downlink reference signal associated with the second antenna group over the second antenna group, and the fourth measurement comprises a measurement of the second downlink reference signal over the first antenna group;
reporting an indication to a network device based on the measurement value, wherein the indication comprises a first type uplink transmission scheme that can be used; and
providing, to the network device, beam information indicating available beams for the first uplink transmission scheme, wherein the beam information comprises:
two or more reference signals;
two or more TCI states;
two or more beams each having a lowest interference level from other beams;
two or more beams each having a highest interference level from other beams;
pairs of beam each pair including one beam of two or more best beam and another beam of the two or more beams having a lowest interference to other beams; and
pairs of beam, wherein each pair includes one beam of two or more best beams, and another beam of the two or more best beams having a highest interference to other beams; and
wherein the indication further comprises a second type of uplink transmission scheme based on a determination that the measurement value is not below the first threshold, wherein the second type of the uplink transmission scheme comprises:
a third scheme in which a same physical uplink shared channel (PUSCH) or demodulation reference signal (DM-RS) is transmitted from different antenna groups using different transmission configuration indicator (TCI) states;
a fourth scheme in which at a same PUSCH transmission occasion, a same PUSCH is transmitted from different antenna groups using different parts of frequency domain resource; and
a fifth scheme in which different PUSCH repetitions with same/different RV of the same transport block (TB) are performed from different antenna groups on non-overlapped frequency domain resources.

37. The method of claim 36, wherein the indication is determined based on the measurement value and a threshold for determining the uplink transmission scheme.

38. The method of claim 37, further comprising transmitting, to the network device, an uplink transmission using an uplink transmission scheme indicated by the indication.
